(19) United States
(12) Patent Application Publication
(10) Pub. No.: US 2002/0013862 A1
(43) Pub. Date: Jan. 31, 2002

(54) Method for data access code generation

(75) Inventors: David B. Orchard, Vancouver (CA); Arvind Viswanathan, Vancouver (CA)

Correspondence Address: IBM Corporation, Intellectual Property Law, Dept. 917, 3605 Highway 52 North, Rochester, MN, 55901, US

(73) Assignee: INTERNATIONAL BUSINESS MACHINES CORPORATION, ARMONK, NY (US)

(21) Appl. No.: 09/838,620

(22) Filed: Apr. 19, 2001

(30) Foreign Application Priority Data
Apr. 28, 2000 (CA) 2,306,933

(51) Int. Cl. G06F 9/44

(52) U.S. Cl. 709/315

(57) ABSTRACT

A method for generating data access classes on an object-oriented environment. A data access code generator takes a least one code generation template and a data object description as inputs and outputs at least one data access class.

### FIELD OF THE INVENTION

This invention relates in general to the field of computer software and more particularly to data access code generation utilizing templates.

### BACKGROUND OF THE INVENTION

The introduction of Java, an object-oriented, multi-threaded, portable, platform-independent, secure-programming environment, and its wide acceptance on the World Wide Web, requires programmers to migrate existing code and develop new code in Java.

In object-oriented programming such as Java, a class is a template definition of the methods and variables in a particular kind of object. For example, classes may be created for graphical user interface elements such as windows and tool bars and also for database interfaces. In general, classes provide an overall framework for developing an application program.

To address the requirements of commercial World Wide Web publishing and enable the expansion of World Wide Web technology, the World Wide Web Consortium has developed an Extensible Markup Language (XML). XML allows the creation of Java-based World Wide Web applications that were not previously possible.

Traditionally, Java classes have been manually created requiring the user to have knowledge of proprietary backend data access Application Program Interfaces (APIs). The manual generation of Java classes can often be complex and very time-consuming resulting in inconsistent code generation. Furthermore, for different APIs, specific Java classes must be generated to provide access to the backend data.

Without a method and apparatus that improves the efficiency of generating data access Java classes, the computer industry will continue to be plagued by inconsistent implementations.

### SUMMARY OF THE INVENTION

According to the invention, there is provided a method and apparatus for data access code generation. A data access code generator routine applies code generation templates to an Extensible Markup Language (XML) document to generate the necessary data access Java classes.

The XML document describes a data object and the mapping of the data object to Java objects. The XML file must be created pursuant to the data model that exists in the backend Application Program Interface (API) as each backend API generally requires specific elements, attributes, and mappings to facilitate backend data access. The details of each data model are defined in a data object Data Type Definition (DTD) document.

The code generation templates contain the support for the backend API data access calls that are required to create the necessary Java classes from the XML file. The code generation template is implemented in any transformation language that can convert XML into Java code.

In operation, the data access code generator routine applies code generation templates to an XML document containing a data object description, which creates the resulting Java classes.

Other objects and advantages of the invention will become clear from the following detailed description of the preferred embodiment, which is presented by way of illustration only and without limiting the scope of the invention to the details thereof.

### BRIEF DESCRIPTION OF THE DRAWINGS

Further features and advantages will be apparent from the following detailed description, given by way of example, of a preferred embodiment taken in conjunction with the accompanying drawings, wherein:

FIG. 1 is a schematic block diagram of a data access code generator system constructed in accordance with the preferred embodiment of the present invention.

### DETAILED DESCRIPTION OF THE INVENTION

Throughout the figures, like elements are indicated by like reference numbers.

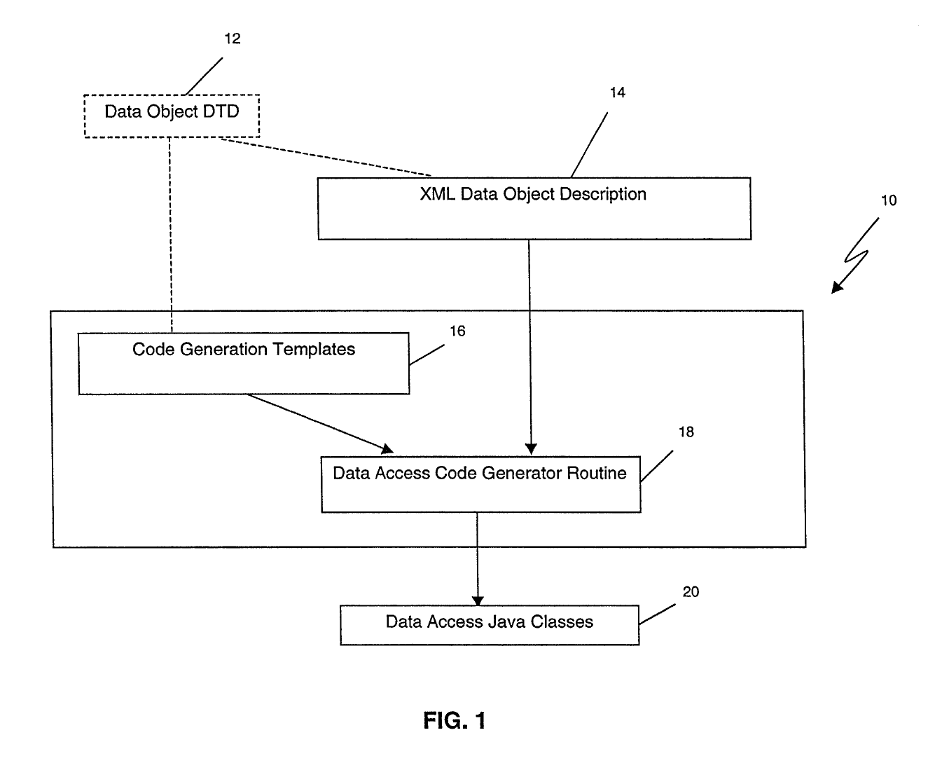

Referring to FIG. 1, a data access code generator 10 of the preferred embodiment is depicted having a data access code generator routine 18 and code generation templates 16.

The data access code generator routine 18 takes the code generation templates 16 and the XML data object description 14 as inputs and produces the necessary data access Java classes 20.

The XML data object description 14 is a document created pursuant to the data model that exists in the backend. The data model is defined in a data object Document Type Definition (DTD) document 12. The data object DTD 12 contains all of the backend APIs definitions for the elements, attributes, and mappings that are required to provide access to the backend data at run-time. For example, a system that accesses a relational database backend will contain attributes and elements for column names and the mapping of the columns to Java attributes.

Every object description contained within the XML data object description 14 must conform to the elements, attributes, and mappings defined in the data object DTD 12. Further, the XML data object description 14 must be supported by the data access code generator routine 18.

The code generation templates 16 describe the code that is generated when the data access code generation routine 18 is invoked. The code generator templates 16 contain the following elements:

data access API calls for the backends that are supported in the data object DTD;

the implementation of system-wide policies such as caching, lazy initialization, logging, and the use of system infrastructure; and

rules for code generation.

In particular, the incorporation of rules for code generation allows for the simple, straightforward, and consistent generation of Java classes.

The code generation templates 16 are implemented in any transformation language that can convert XML into Java code. For example, the code generation templates 16 can be implemented in a transform mechanism such as Extensible Stylesheet Language (XSL), in which case the code generation templates 16 are actually XML files.

In operation, the method and apparatus for data access code generation commences with an author creating an XML data object description 14 describing a data object. The description of the data object must conform to the elements, attributes, and mappings defined in the data object DTD 12. The data access code generator routine 18 then takes the code generation templates 16 and the XML data object description 14 as inputs and produces the necessary data access Java classes 20 to provide access to the backend data at run-time.

One of the advantages of using a data access code generator routine 18 in conjunction with the code generation templates 16 is that programmers need not learn the proprietary backend APIs. The specific calls for each proprietary backend API are contained only in the code generation templates 16, where they are applied to the XML data object description 14 to create the necessary data access Java classes 20. This provides the further advantage of allowing the protection of proprietary information as programmers may be provided with the code generation templates 16 instead of the details of each proprietary backend API.

This method and apparatus also provide the advantage of allowing system-wide changes and enhancements to be made by simply regenerating the data access Java classes using modified code generation templates 16 or by simply modifying the data object description in the XML document 14.

Furthermore, through simply modifying the code generation templates 16, different policies can be applied without the need to edit each of the resulting data access Java classes 20.

Therefore, this method and apparatus for data access code generation provides the advantages of modifiability, extensibility, adaptation, and reusability. The modifiability of the data object description in the XML document and the code generator templates provides clear advantages over the manual creation and modification of Java classes. Consequently, a single XML data object description may be used in conjunction with several different code generation templates to create data access Java classes for different backend APIs. Furthermore, the code generation templates can be modified to include system modifications and the data access Java classes regenerated without the need to edit each resulting data access Java class.

Accordingly, while this invention has been described with reference to illustrative embodiments, this description is not to be construed in a limiting sense. Various modifications of the illustrative embodiments, as well as other embodiments of the invention, will be apparent to persons skilled in the art upon reference to this description.

For example, any object-oriented programming environment, such as C++, may be substituted for Java. Furthermore, a single code generation template may be used, or a plurality of code generation templates may be used. Similarly, the data access code generator routine may create a single data access Java class or it may create a plurality of data access Java classes.

It is therefore contemplated that the appended claims will cover any such modifications or embodiments as fall within the true scope of the invention.

What is claimed is:

1. A method of data access code generation, comprising:
a) describing a data object in a data object description document;
b) applying at least one code generation template to said data object description document;
c) generating at least one data access class.

2. The method according to claim 1, wherein said data object description document conforms to a data object document type definition.

3. The method according to claim 1, wherein steps b) and c) are performed by a data access code generator routine.

4. The method according to claim 1, wherein said at least one data access class is a data access Java class.

5. The method according to claim 1, wherein said data object description document is created in Extensible Markup Language (XML).

6. The method according to claim 1, wherein said at least one code generation template is implemented in a transformation language.

7. The method according to claim 6, wherein said transformation language is Extensible Stylesheet Language (XSL).

8. The method according to claim 3, wherein said data access code generator takes said data object description document and said at least one code generation template as inputs and outputs said at least one data access class.

9. A method of generating data access Java classes, comprising:
a) creating a XML data object description;
b) applying a plurality of code generation templates to said XML data object description;
c) generating at least one data access Java class.

10. The method according to claim 9, wherein said XML data object description is created pursuant to a data object document type definition.

11. The method according to claim 9, wherein steps b) and c) are performed by a data access code generator routine.

12. The method according to claim 11, wherein said data access code generator takes said XML data object description and said at least one code generation template as inputs and outputs said at least one data access Java class.

13. A method of data access code generation in an object-oriented programming environment, comprising:
a) describing a data object in a data object description document;
b) applying at least one code generation template to said data object description document;
c) generating at least one data access class.

14. The method according to claim 13, wherein said object-oriented programming environment is Java.

15. The method according to claim 13, wherein said data object description document conforms to a data object document type description.

16. The method according to claim 13, wherein said code generation template is an Extensible Stylesheet Language (XSL) document.

17. An apparatus for generating data access code comprising:
a) a data object descriptor;
b) a least one code generation template; and
c) a code generator operative to generate at least one data access class.

18. The apparatus according to claim 17, wherein said data object descriptor is operative to describe a data object that conforms to a data object document type definition.

19. The apparatus according to claim 17, wherein said at least one code generation template is operative to define the transformation of said data object description to said at least one data access class.

20. The apparatus according to claim 17, wherein said at least one data access class is a data access Java class.

21. The apparatus according to claim 17, wherein said data object descriptor is created in Extensible Markup Language (XML).

22. A program product, said program product comprising:
a) memory; and
b) a data access code generator stored on said memory, said data access code generator being configured to perform the steps of,
i) describing a data object in a data object description document;
ii) applying at least one code generation template to said data object description document; and
iii) generating at least one data access class.

23. The program product of claim 22, wherein said data object description document conforms to a data object document type definition.

24. The program product of claim 22, wherein said at least one data access class is a data access Java class.

25. The program product of claim 22, wherein said data object description document is created in Extensible Markup Language (XML).

26. The program product of claim 22, wherein said at least one code generation template is implemented in a transformation language.

27. The program product of claim 26, wherein said transformation language is Extensible Stylesheet Language (XSL).

28. The program product of claim 24, wherein said data access code generator takes said data object description document and said at least one code generation template as inputs and outputs said at least one data access class.

29. A program product, said program product comprising:
a) memory; and
b) a program stored on said memory, said program being configured to perform the steps of,
i) creating a XML data object description;
ii) applying a plurality of code generation templates to said XML data object description; and
iii) generating at least one data access Java class.

30. The program product of claim 29, wherein said XML data object description is created pursuant to a data object document type definition.

31. The program product of claim 29, wherein steps ii) and iii) are performed by a data access code generator routine.

32. The program product of claim 31, wherein said data access code generator takes said XML data object description and said at least one code generation template as inputs and outputs said at least one data access Java class.

33. A program product, said program product comprising:
a) memory; and
b) a program stored on said memory, said program being configured to perform the steps of,
i) describing a data object in a data object description document;
ii) applying at least one code generation template to said data object description document;
iii) generating at least one data access class.

34. The program product of claim 33, wherein said object-oriented programming environment is Java.

35. The program product of claim 33, wherein said data object description document conforms to a data object document type description.

36. The program product of claim 33, wherein said code generation template is an Extensible Stylesheet Language (XSL) document.
